(19) United States
(12) Patent Application Publication
(10) Pub. No.: US 2019/0216583 A1
(43) Pub. Date: Jul. 18, 2019

(54) ALL-AROUND FULL-AUTOMATIC MOUTH HOLDING TYPE BRUSHING-PROTECTING INTEGRATED INTELLIGENT TOOTHBRUSH

(71) Applicant: BAIRUI ORAL CARE (ZHUHAI) CO., LTD., Zhuhai (CN)

(72) Inventors: Lirong Zhuo, Zhuhai (CN); Wenhu Liu, Zhuhai (CN); Sean Creaghan, Zhuhai (CN)

(21) Appl. No.: 16/008,001

(22) Filed: Jun. 13, 2018

(30) Foreign Application Priority Data
Jan. 17, 2018 (CN) 201810044559.2

(51) Int. Cl. A61C 17/22; A46D 1/00; A61C 15/04; A61C 17/02; A61C 17/34

(52) U.S. Cl. CPC A61C 17/228; A46D 1/0284; A46D 1/0207; H02J 7/0044; A61C 17/0211; A61C 17/224; A61C 17/3481; A61C 15/047

(57) ABSTRACT

Disclosed is an all-around full-automatic mouth holding type brushing-protecting integrated intelligent toothbrush. The toothbrush includes a crown, a host machine and a charging base; the host machine is arranged at a bottom of the crown; an adapter is arranged between the crown and the host machine; the crown and the adapter are connected via a stepped screw thread; the host machine and the adapter are connected via a clamping buckle. According to the all-around full-automatic mouth holding type brushing-protecting integrated intelligent toothbrush, the problems that the existing toothbrush has a long brushing time and needs to be held by a hand, and a toothbrush head cannot completely and accurately clean each position of teeth without a dead angle are effectively solved.

### CROSS REFERENCE TO RELATED APPLICATIONS

The present application claims the benefit of Chinese Patent Application No. 201810044559.2 filed on Jan. 17, 2018. All the above are hereby incorporated by reference.

### TECHNICAL FIELD

The disclosure relates to the field of daily living goods, and more particularly, to an all-around full-automatic mouth holding type brushing-protecting integrated intelligent toothbrush.

### BACKGROUND OF THE INVENTION

For existing electric and manual toothbrushes, it is relatively time-consuming because there is a need to stay a period of time on each of dental faces and three dental faces are considered to achieve the purpose of cleaning the teeth. Therefore, when the electric toothbrush is used, enough patience is required such that the teeth are cleaned really. If the toothbrush is placed into the mouth only and is not moved up and down synchronously, pathogenic bacteria on special sites of the teeth such as pits and fissures, gingival sulcuses and slits between the teeth cannot be thoroughly cleaned and the tooth diseases will be caused. To correctly use the electric toothbrush really has the effects of removing dental plaques and preventing tooth decay and periodontitis. However, these effects are nothing but the same as a common toothbrush. The electric toothbrush only changes a brushing manner of people but cannot replace the tooth cleaning effect completely. Moreover, the vibration frequency and the force of the electric toothbrush are relatively fixed, so it is similar to horizontal brushing on the tooth surface during rotation and a certain abrasion may be caused to the teeth or even the periodontitis may be suffered in a serious condition. If the teeth are not very good intrinsically, for example, suffering from gingivitis and periodontitis, it is best not to choose the electric toothbrush. Furthermore, a child cannot master how to use the electric toothbrush appropriately and quickly. As a result, it is easy to damage the tender gums such that the gums have symptoms like redness. And meanwhile, the teeth further will be vigorously worn and even the periodontitis or loss of teeth will be caused in the serious condition. Additionally, all of the existing toothbrushes do not solve the problems of cancelling hand holding and implementing full automation. A handheld toothbrush cannot enable a toothbrush head to contact each of the dental faces and a correct position of each face and cannot achieve the complete cleaning effect. And the tooth brushing time is relatively long and it requires 3-5 min.

Therefore, it is very necessary to provide an all-around full-automatic mouth holding type brushing-protecting integrated intelligent toothbrush to solve the above problems.

### SUMMARY OF THE INVENTION

The disclosure is intended to provide an all-around full-automatic mouth holding type brushing-protecting integrated intelligent toothbrush so as to solve the problems in the background.

To this end, the technical solutions provided by the disclosure are as follows: an all-around full-automatic mouth holding type brushing-protecting integrated intelligent toothbrush, includes a crown, a host machine and a charging base; the host machine is arranged at a bottom of the crown; an adapter is arranged between the crown and the host machine; the crown and the adapter are connected via a stepped screw thread; the host machine and the adapter are connected via a clamping buckle; the host machine includes a host machine upper shell and a host machine lower shell; a first waterproof ring is arranged at a junction of the host machine upper shell and the host machine lower shell; a motor bracket is arranged in the host machine; the motor bracket includes a first bracket and a second bracket; the first bracket and the second bracket are connected in a clamping manner; an acoustic motor is arranged between the first bracket and the second bracket; a battery is arranged at a bottom of the acoustic motor; the acoustic motor and the battery both are arranged inside the motor bracket; a host machine PCB board is arranged at one side of the first bracket; a button is arranged on a surface of the host machine; the button is electrically connected with the host machine PCB board; the charging base is arranged at a bottom of the host machine; the charging base includes a first base housing and a second base housing; the first base housing and the second base housing are movably connected via a rotating shaft; each of the first base housing and the second base housing includes an upper housing and a lower housing; a volute-shaped water leaking hole is formed on a top of the upper housing of the first base housing; a base PCB board is arranged inside the first base housing; an electric coil is arranged at a bottom of the base PCB board; rubber pads are arranged at a bottom of the charging base.

Preferably, the crown is of a U shape and is designed according to oral ergonomics; bristles are arranged on an inner wall of the crown; the top ends of the bristles are ground to be round; the bristles are placed at intersections of teeth and gums obliquely at 45°, which is a core technology of contemporary scientific tooth brushing; the bristles are made of a food grade silica gel material into which an antibacterial component is injected.

Preferably, a silica gel soft brush is arranged in a U-shaped groove of the crown; the U-shaped groove and the silica gel soft brush are arranged into an integral connecting structure; the hardness of the silica gel soft brush is smaller than that of the U-shaped groove of the crown.

Preferably, a waterproof silica gel is arranged at a junction of the host machine and the adapter; the waterproof silica gel is of a volute shape.

Preferably, an air vent is formed at a bottom of the host machine lower shell; a waterproof film is attached inside the air vent.

Preferably, a water flushing nozzle or a water dental floss flushing accessory can be selected by the crown.

Preferably, a second waterproof ring is arranged at a junction of the upper housing and the lower housing of the first base housing; the second waterproof ring is covered out of the base PCB board and the electric coil.

Preferably, bumps are arranged at a bottom of the lower housing of the second base housing.

Preferably, a wireless charging coil is attached on a top of each of the host machine lower shell and the upper housing of the first base housing.

Preferably, four rubber pads are provided; the four rubber pads are respectively arranged at four corner positions of the bottom of the charging base.

The disclosure achieves the following technical effects and advantages.

1. The disclosure is vibrated via the acoustic motor; then, the vibration is transferred to the crown via the adapter; and moreover, an ebonite portion on the crown transfers the vibration to the antibacterial food grade silica gel bristles on the inner wall of the U-shaped crown and the silica gel bristles are swung left and right because of the vibration; when the crown is held by a mouth of a person, the bristles on an inner periphery may clean the teeth and impurities in each slit between the teeth are discharged easily; the bristles on an outer periphery may contact the gums exactly; when the bristles are swung, the gums may be massaged deeply, such that the blood circulation of the gums is improved and the cell metabolism is promoted; meanwhile, the soft antibacterial food grade silica gel bristles can be applied to various different oral cavities and teeth, prevents the gum bleeding, makes both the gums and the teeth more healthy and further can beautify the teeth. In addition, under the action of the acoustic motor, the silica gel soft brush in the U-shaped groove of the crown further can take the effect of cleaning and massaging the coated tongue.

2. A wireless charging manner is adopted by the bottom of the disclosure, so both hands may be liberated, the toothbrush is more convenient, quicker and safer, and the both hands can do other things while the teeth are brushed.

3. The first base housing and the second base housing that are movably connected are adopted, so when the second base housing is rotated to be pulled open, two crowns may be placed thereon and the bump structure on the second base housing can place the graces well; when the crowns are placed on the second base housing, they cannot be dropped off easily; when the toothbrush is not used, the second base housing can be rotated to close with the main housing and the whole wireless charging housing is formed into a whole.

### BRIEF DESCRIPTION OF THE DRAWINGS

FIG. 1 is a systematic diagram of an overall structure of the disclosure.

FIG. 2 is an overall breakdown diagram of the disclosure.

In the drawings: 1. a crown; 2. a host machine; 3. an adapter; 4. a host machine upper shell; 5. a host machine lower shell; 6. a first waterproof ring; 7. a wireless charging coil; 8. a motor bracket; 9. a first bracket; 10. a second bracket; 11. an acoustic motor; 12. a battery; 13. a host machine PCB board; 14. a button; 15. a charging base; 16. a first base housing; 17. a second base housing; 18. a base PCB board; 19. an electric coil; 20. a rubber pad; 21. bristles; 22. a waterproof silica gel; 23. an air vent; 24.

a volute-shaped water leaking hole; 25. a second waterproof ring; 26. a bump; 27. a silica gel soft brush.

### DETAILED DESCRIPTION OF THE INVENTION

The following clearly and completely describes the technical solutions in the embodiments of the disclosure with reference to the accompanying drawings in the embodiments of the disclosure. Apparently, the described embodiments are a part rather than all of the embodiments of the disclosure. All other embodiments obtained by a person of ordinary skill in the art based on the embodiments of the disclosure without creative efforts shall fall within the protection scope of the disclosure.

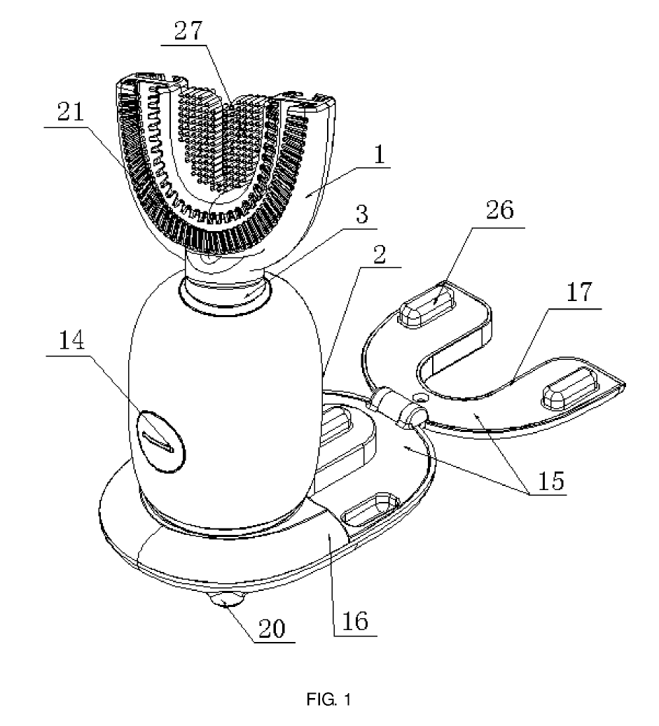

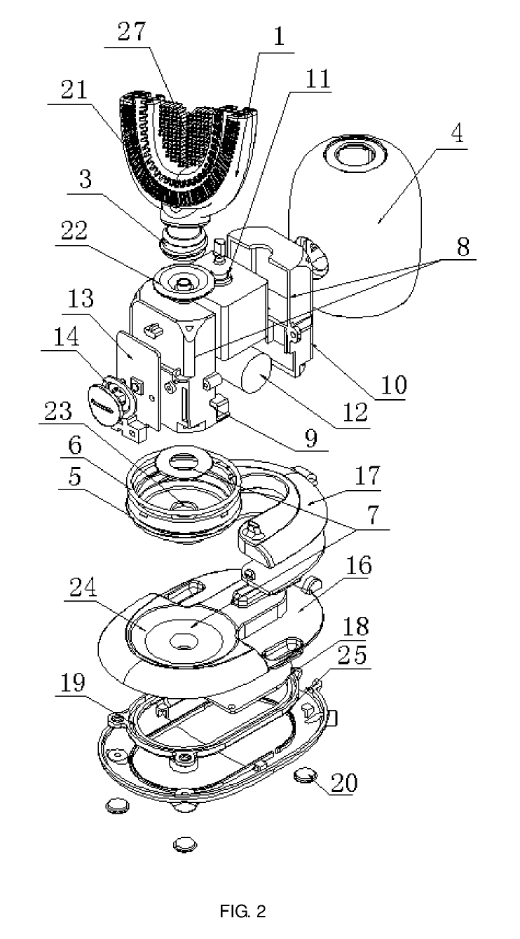

The disclosure provides an all-around full-automatic mouth holding type brushing-protecting integrated intelligent toothbrush as shown in FIG. 1-2. It includes a crown 1, a host machine 2 and a charging base 15; the host machine 2 is arranged at a bottom of the crown 1; an adapter 3 is arranged between the crown 1 and the host machine 2; the crown 1 and the adapter 3 are connected via a stepped screw thread; the host machine 2 and the adapter 3 are connected via a clamping buckle; the host machine 2 includes a host machine upper shell 4 and a host machine lower shell 5; a first waterproof ring 6 is arranged at a junction of the host machine upper shell 4 and the host machine lower shell 5; a motor bracket 8 is arranged in the host machine 2; the motor bracket 8 includes a first bracket 9 and a second bracket 10; the first bracket 9 and the second bracket 10 are connected in a clamping manner; an acoustic motor 11 is arranged between the first bracket 9 and the second bracket 10 and a vibration can be transferred via a motor shaft; when the motor 3 is vibrated, the vibration is transferred to the crown via the adapter 2; a battery 12 is arranged at a bottom of the acoustic motor 11; the acoustic motor 11 and the battery 12 both are arranged inside the motor bracket 8; a host machine PCB board 13 is arranged at one side of the first bracket 9; a button 14 is arranged on a surface of the host machine 2; the button 14 is electrically connected with the host machine PCB board 13; the charging base 15 is arranged at a bottom of the host machine 2; the charging base 15 includes a first base housing 16 and a second base housing 17; the first base housing 16 and the second base housing 17 are movably connected via a rotating shaft; each of the first base housing 16 and the second base housing 17 includes an upper housing and a lower housing; a volute-shaped water leaking hole 24 is formed on a top of the upper housing of the first base housing 16, such that the dropping water on the surface may be evacuated well and is prevented from being accumulated on the charging base 15; a base PCB board 18 is arranged inside the first base housing 16; an electric coil 19 is arranged at a bottom of the base PCB board 18; rubber pads 20 are arranged at a bottom of the charging base 15.

The crown 1 is of a U shape and is designed according to oral ergonomics; bristles 21 are arranged on an inner wall of the crown 1; the top ends of the bristles 21 are ground to be round; the bristles 21 are placed at intersections of teeth and gums obliquely at 45°, which is a core technology of contemporary scientific tooth brushing; the bristles 21 are made of a food grade silica gel material into which an antibacterial component is injected; the slits between the teeth can be cleaned deeply and teeth are cleaned accurately at 360° in an all-around manner without a dead angle, so the tooth brushing time is greatly shortened; moreover, the toothbrush is applied to various different oral cavities and teeth, prevents the gum bleeding, and makes the gums more healthy and whiter.

A silica gel soft brush 27 is arranged in a U-shaped groove of the crown 1; the U-shaped groove and the silica gel soft brush 27 are arranged into an integral connecting structure; the hardness of the silica gel soft brush 27 is smaller than that of the U-shaped groove of the crown 1, such that smelly bacteria on an outer surface of a tongue can be removed well.

A waterproof silica gel 22 is arranged at a junction of the host machine 2 and the adapter 3; the waterproof silica gel 22 is of a volute shape such that the water can be effectively prevented from entering.

An air vent 23 is formed at a bottom of the host machine lower shell 5, such that the heat generated by the acoustic motor 11 may be dissipated; a waterproof film is attached inside the air vent 23, such that the water outside can be effectively prevented from splashing into the machine.

A water flushing nozzle or a water dental floss flushing accessory can be selected by the crown 1, and a gentle flushing water stream controlled automatically at 10 s can replace a toothbrush head, thereby implementing the all-around cleaning to residues on the surface of the oral cavity.

A second waterproof ring 25 is arranged at a junction of the upper housing and the lower housing of the first base housing 16; the second waterproof ring 25 is covered out of the base PCB board 18 and the electric coil 19, such that a sealed space may be formed inside to take a good waterproof effect.

Bumps 26 is arranged at a bottom of the lower housing of the second base housing 17 and can be configured to fix the crown 1 such that the crown 1 cannot be dropped off easily.

A wireless charging coil 7 is attached on a top of each of the host machine lower shell 5 and the upper housing of the first base housing 16, such that the battery 12 inside the host machine 2 can be charged via a radio.

Four rubber pads 20 are provided; the four rubber pads 20 are respectively arranged at four corner positions of the bottom of the charging base 15; when the rubber pads are placed to use, the whole device can be prevented from sliding.

Working principles of the disclosure are as follows: when the toothbrush is used, the crown 1 is screwed to the adapter 3 on the host machine 2 first; then, the crown 1 is held by a mouth and the button 14 is pressed such that the acoustic motor 11 starts to vibrate; the vibration generated by the acoustic motor 11 is transferred to the crown 1 via the adapter 3; the ebonite portion on the crown 1 transfers the vibration to the silica gel soft bristles 21 on the U-shaped crown 1 and the bristles 21 will be swung left and right because of the vibration; when the crown is held by the mouth of a person, the bristles 21 on an inner periphery may clean the teeth and impurities in each slit between the teeth are discharged easily; the bristles 21 on an outer periphery may contact the gums exactly; when the bristles are swung, the messaging effect may be taken; the whole cleaning process only needs 3-5 s; and during tooth brushing, both hands may do other things. Thus, the whole use process is very convenient, quick and safe.

At last, it should be noted that the above are only preferred embodiments of the disclosure and are not intended to limit the disclosure. Although the disclosure is described in detail with reference to the above embodiments, a person of skilled in the art still may make modification on the technical solutions in each of the foregoing embodiments or make equivalent replacement for some technical characteristics. Any modification, equivalent replacement, improvement and the like made within the spirits and principles of the disclosure should be included in a scope of protection of the disclosure.

What is claimed is:

1. An all-around full-automatic mouth holding type brushing-protecting integrated intelligent toothbrush, comprising a crown (1), a host machine (2) and a charging base (15), wherein the host machine (2) is arranged at a bottom of the crown (1); an adapter (3) is arranged between the crown (1) and the host machine (2); the crown (1) and the adapter (3) are connected via a stepped screw thread; the host machine (2) and the adapter (3) are connected via a clamping buckle; the host machine (2) comprises a host machine upper shell (4) and a host machine lower shell (5); a first waterproof ring (6) is arranged at a junction of the host machine upper shell (4) and the host machine lower shell (5); a motor bracket (8) is arranged in the host machine (2); the motor bracket (8) comprises a first bracket (9) and a second bracket (10); the first bracket (9) and the second bracket (10) are connected in a clamping manner; an acoustic motor (11) is arranged between the first bracket (9) and the second bracket (10); a battery (12) is arranged at a bottom of the acoustic motor (11); the acoustic motor (11) and the battery (12) both are arranged inside the motor bracket (8); a host machine PCB board (13) is arranged at one side of the first bracket (9); a button (14) is arranged on a surface of the host machine (2); the button (14) is electrically connected with the host machine PCB board (13); the charging base (15) is arranged at a bottom of the host machine (2); the charging base (15) comprises a first base housing (16) and a second base housing (17); the first base housing (16) and the second base housing (17) are movably connected via a rotating shaft; each of the first base housing (16) and the second base housing (17) comprises an upper housing and a lower housing; a volute-shaped water leaking hole (24) is formed on a top of the upper housing of the first base housing (16); a base PCB board (18) is arranged inside the first base housing (16); an electric coil (19) is arranged at a bottom of the base PCB board (18); rubber pads (20) are arranged at a bottom of the charging base (15).

2. The all-around full-automatic mouth holding type brushing-protecting integrated intelligent toothbrush according to claim 1, wherein the crown (1) is of a U shape and is designed according to oral ergonomics; bristles (21) are arranged on an inner wall of the crown (1); the top ends of the bristles (21) are ground to be round; the bristles (21) are placed at intersections of teeth and gums obliquely at 45°, which is a core technology of contemporary scientific tooth brushing; the bristles (21) are made of a food grade silica gel material into which an antibacterial component is injected.

3. The all-around full-automatic mouth holding type brushing-protecting integrated intelligent toothbrush according to claim 1, wherein a silica gel soft brush (27) is arranged in a U-shaped groove of the crown (1); the U-shaped groove and the silica gel soft brush (27) are arranged into an integral connecting structure; the hardness of the silica gel soft brush (27) is smaller than that of the U-shaped groove of the crown (1).

4. The all-around full-automatic mouth holding type brushing-protecting integrated intelligent toothbrush according to claim 1, wherein a waterproof silica gel (22) is arranged at a junction of the host machine (2) and the adapter (3); the waterproof silica gel (22) is of a volute shape.

5. The all-around full-automatic mouth holding type brushing-protecting integrated intelligent toothbrush according to claim 1, wherein an air vent (23) is formed at a bottom of the host machine lower shell (5); a waterproof film is attached inside the air vent (23).

6. The all-around full-automatic mouth holding type brushing-protecting integrated intelligent toothbrush according to claim 1, wherein a water flushing nozzle or a water dental floss flushing accessory can be selected by the crown (1).

7. The all-around full-automatic mouth holding type brushing-protecting integrated intelligent toothbrush according to claim 1, wherein a second waterproof ring (25) is arranged at a junction of the upper housing and the lower housing of the first base housing (16); the second waterproof ring (25) is covered out of the base PCB board (18) and the electric coil (19).

8. The all-around full-automatic mouth holding type brushing-protecting integrated intelligent toothbrush according to claim 1, wherein bumps (26) are arranged at a bottom of the lower housing of the second base housing (17).

9. The all-around full-automatic mouth holding type brushing-protecting integrated intelligent toothbrush according to claim 1, wherein a wireless charging coil (7) is attached on a top of each of the host machine lower shell (5) and the upper housing of the first base housing (16).

10. The all-around full-automatic mouth holding type brushing-protecting integrated intelligent toothbrush according to claim 1, wherein four rubber pads (20) are provided; the four rubber pads (20) are respectively arranged at four corner positions of the bottom of the charging base (15).
